(19) United States
(12) Patent Application Publication
(10) Pub. No.: US 2005/0143863 A1
(43) Pub. Date: Jun. 30, 2005

(54) Building control system field panel having integrated web server

(76) Inventors: Margaret Ruane, Deerfield, IL (US); David Swoch, Rolling Meadows, IL (US)

Correspondence Address: Harold C. Moore;Maginot, Moore & Beck, Bank One Center/Tower, 111 Monument Circle, Suite 3000, Indianapolis, IN, 46204-5115, US

(21) Appl. No.: 11/018,847

(22) Filed: Dec. 20, 2004

Related U.S. Application Data
(60) Provisional application No. 60/531,196, filed on Dec. 19, 2003.

(51) Int. Cl. G05B 15/00

(52) U.S. Cl. 700/276

(57) ABSTRACT

A controller for use in a building control system includes an input, an output, a processing circuit and a communication circuit. The input is operably connected to receive sensor information. The output is operably connected to communicate control information. The processing circuit is configured to generate the control information based on the sensor information and at least one set point. The processing circuit is further operable to generate web pages including one or more building control values. The communication circuit is operable to communicate the generated web pages to an external web client. The communication circuit is preferably further operable to communicate an executable program to the external web client. The executable program is configured to cause the external web client to automatically poll for updates to at least one of the one or more building control values.

This application claims the benefit of U.S. Provisional Patent Application Ser. No. 60/531,196, filed Dec. 19, 2003 and which is incorporated herein by reference.

### FIELD OF THE INVENTION

The present invention relates generally to building control systems, and more particularly, to building control systems that include field panel control devices.

### BACKGROUND OF THE INVENTION

Building control systems are employed to regulate and control various environmental and safety aspects of commercial, industrial and residential facilities (hereinafter referred to as “buildings”). In ordinary single-family residences, control systems tend to be simple and largely unintegrated. However, in larger buildings, building control systems often consist of multiple, integrated subsystems employing hundreds of elements.

One common type of building control system is a heating, ventilation and air-conditioning (“HVAC”) building control system. An HVAC system interrelates small, local control loops with larger control loops to coordinate the delivery of heat, vented air, and chilled air to various locations throughout a large building. Local control loops may be used for various purposes, including, for example, opening and closing vents that supply heated or chilled air based on local room temperature readings. Larger control loops, however, may be used to obtain several distributed temperature readings and/or air flow readings that can be used to control the speed of a ventilation fan, or to control the operation of heating or chilling equipment.

As a consequence of the interrelationship of these control loops, many elements of a building control system must communicate information to each other. To this end, communication networks have been incorporated that transmit digital data between and among the various elements in accordance with one or more sets of protocols.

Some of the core elements of a sophisticated building control systems include field panel devices, supervisory control stations, sensors and actuators. Sensors and actuators are terminal devices of the system that collect raw data and physically change output of the system, respectively. For example, sensors may include temperature sensors, humidity sensors, air flow sensors and the like. Actuators may change the physical output of fans, ventilation dampers, air conditioning equipment and the like.

Field panel devices are distributed control devices that in large part determine the operation of the system, at least at the local control loop level. To this end, field panel devices may receive sensor signals from the sensors and provide control signals to the actuators. The field panel devices generate the control signals based on the sensor signals and other control signals or set point signals received from other field panel devices.

A supervisory control station is typically a computer work station having a human user interface that allows technicians to monitor and control overall system operation. Control stations may be used to track alarm conditions, overall performance, and provide a user interface to system variables.

In such systems, the field panel devices are generally connected to each other, as well as to the one or more control stations, in order to share information necessary for coherent building control. In the past, such devices shared data over a token ring network, which are relatively simple to implement on a logical level. However, more recently, field panel devices can communicate with each other, and with control stations, over logical networks on an Ethernet backbone.

One aspect of many building control systems is that the communication protocols used by the field panel devices is typically somewhat specialized, and often proprietary in nature. Thus, access to building control system data is largely limited to devices especially configured for use in the building control system. Thus, in a typical system, a user must employ the user interface at one of the field panel devices, or at the supervisory control station to view or control building control system data.

There have been proposals to allow access to building control data using the World Wide Web, thereby allowing access to system data from normal web-compatible computers. Such systems thereby allow computers that have not been specially configured to access at least some building control system information. One such system is disclosed in U.S. Pat. No. 6,157,943, which describes a system that enables web access to building control system data through a specialized standalone Internet web server. One drawback is that the system has limited capability and flexibility, and furthermore requires a specialized web server host.

There is a need, therefore, for a method or apparatus for use in a building control system that provides broader access such as web access to building control information, and which addresses one or more drawbacks of prior web-capable systems.

### SUMMARY OF THE INVENTION

The present invention addresses the above needs, as well as others, by providing a controller (e.g. a field panel) that performs ordinary building control functions and furthermore operates as a web server. Thus, a web client may access building control information directly from a field panel or controller without specialized protocols, even if the field panel uses specialize protocols for normal building control operations. The field panel web server preferably further includes the capability of selectively using advanced web features to provide automatic updates of at least some building control information to the web client.

A first embodiment of the invention is a controller for use in a building control system. The controller includes an input, an output, a processing circuit and a communication circuit. The input is operably connected to receive sensor information. The output is operably connected to communicate control information. The processing circuit is configured to generate the control information based on the sensor information and at least one set point. The processing circuit is further operable to generate web pages including one or more building control values. The communication circuit is operable to communicate the generated web pages to an external web client. The communication circuit is preferably further operable to communicate an executable program to the external web client. The executable program is configured to cause the external web client to automatically poll for updates to at least one of the one or more building control values.

A second embodiment of the invention is a related method for use in a building control system that includes a field panel or controller.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a block diagram of an exemplary system that incorporates an embodiment of the invention.

FIG. 2 shows a block diagram of another exemplary system that incorporate embodiments of the invention.

FIG. 3 shows a schematic block diagram of an exemplary field panel that incorporates aspects of the present invention.

FIG. 4 shows in further detail the software functions or element carried out in the field panel of FIG. 3.

FIG. 5 shows a flow diagram of an exemplary set of operations performed by the web server of the field panel of FIG. 3.

FIG. 6 shows an exemplary HTML page generated by the web server of the field panel of FIG. 3.

FIG. 7 shows an exemplary flow diagram of the operations of a client/user and various software elements of the field panel of FIG. 3.

### DETAILED DESCRIPTION

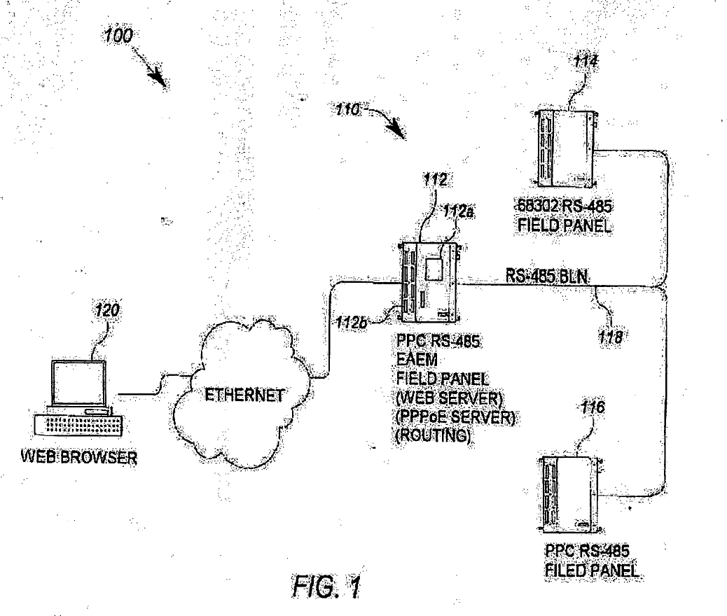

FIG. 1 shows a block diagram of an exemplary system 100 that incorporates an embodiment of the invention. The system includes a building control system 110 having three field panels 112, 114 and 116 connected by a communication network 118. Each of the field panels 112, 114 and 116 is operably connected to one or more sensor devices and/or actuators, not shown in FIG. 1. At least some of the field panels 112, 114 and 116 are operable to generate control signals (output signals) that effect operation of a physical device (i.e. an actuator), not shown, based at least in part on input from one or more sensor devices. The physical device may suitably be a ventilation damper actuator, water valve actuator, or the like.

In general, the field panels 112, 114 and 116 share building control data with each other. In other words, the field panel 112 can request and obtain certain data from the field panel 114 over the communication network 118. To obtain data from other field panels, the communication network 118 may be any communication network commonly used for HVAC field panel communications. For example, the communication network 118 may suitably be an Ethernet network, a token pass or token ring network, or any other standard communication network. Field panels and communication networks having the general operations discussed above are well known in the art.

In accordance with aspects of the present invention, however, the field panel 112 is further operable to perform web server operations. In particular, the field panel 112 includes a processing circuit 112a configured to generate web pages (or other web-browser compatible data files) that include one or more building control values. The field panel 112 further includes at least one communication circuit 112b operable to communicate the generated web browser compatible files to an external web client 120. The communication circuit 112b is further operable to communicate an executable program to the external web client 120, the executable program operable to cause the external web client 120 to automatically poll for updates to at least one of the one or more building control values.

In this embodiment, the web client 120 is connected to the field panel 112 via an Ethernet network. However, the web client 120 may be connected to the web server 120 using other known configurations.

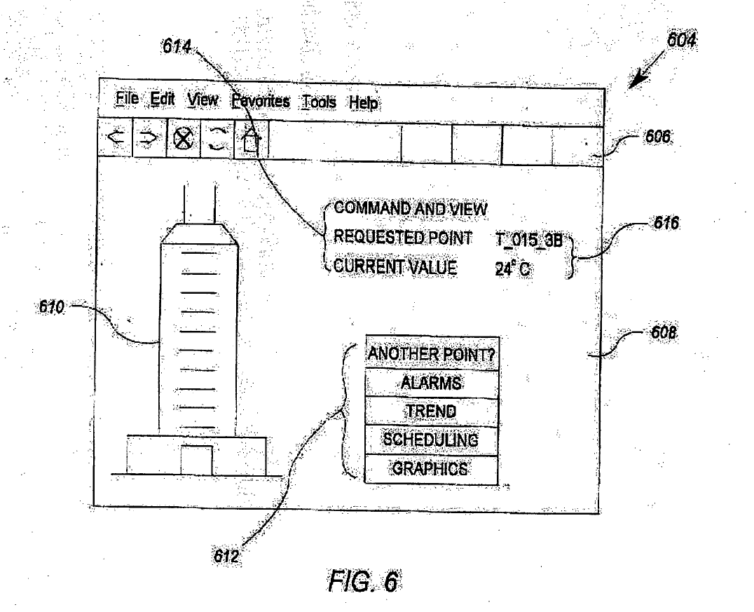

In some embodiments described herein, the web browser compatible file that is generated by the processing circuit 112 is an HTML-based web page that is readily displayed using most commercially available web browsers. The web page may include sensor values of the building control system. For example, the web page may display temperature sensor values for one or more rooms in a building. The web page also typically includes static text and/or graphics as is known in the art for HTML-based web pages. The static text and/or graphics may suitably form the template or background for the transmitted building control values. FIG. 6, discussed further below, shows an exemplary web page having static information 610, 614 and information representative of building control values 616.

In accordance with one aspect of the invention, the processing circuit 112a can generate a web page that includes building control data that is maintained locally within the field panel 112, or alternatively that is obtained from one of the other field panels 114 and 116 via the communication network 118.

The executable program that is communicated may suitably include a Java script or Java applet that causes the external web client 120 to automatically request updates to certain values, for example, alarm values, from one or more of the field panels 112, 114 and 116. Other applets or scripts may also be downloaded to enable entry and verification of certain input from the web client 120 user.

In the general operation of the system of FIG. 1, the field panel 112 generally controls various aspects of a building control system using inputs from sensors and other devices. For example, the field panel 112 can control a ventilation damper to regulate the flow of cooling air into one or more rooms of a building. To this end, the ventilation damper may be further opened or closed based on the measured room temperature and a desired temperature set point. In such an operation, the field panel 112 typically receives the measured room temperature and set point data and generates an output signal that defines how much the ventilation damper should be opened or closed.

The field panels 114 and 116 also perform similar control operations. In addition, other field panels, not shown, may also control larger HVAC equipment such as chiller plants, blowers and the like. It will be appreciated that field panels such as the field panels 112, 114 and 116 may alternatively be used in a non-HVAC system, such as a fire safety or security system.

Regardless of what system they are implemented in, the field panels 112, 114 and 116 from time to time communicate and share data in the course of performing building control functions such as those described above. Field panel to field panel communication over a network such as the communication network 118 is well known in the art and is employed, for example, in the APOGEE™ family of building control systems available from Siemens Building Technologies, Inc. of Buffalo Grove, Ill. Such communications typically employ protocols that are configured primarily for building/industrial control operations, such as the LonTalk protocol, the BACnet protocol and/or proprietary protocols. Typical values that may be shared from field panel to field panel include values of sensors (e.g. temperatures, air flow measurements), values of actuators (e.g. position of ventilator shaft, fan speed), alarms (sensor values out of normal range), scheduling information (changes in controls based on time of day, date or season), reports (maintained in each field panel for its controlled points) and set points. It is known in the art that field panels can also perform statistical trending. Such information may also be shared from field panel to field panel.

One of the reasons that extended information may be shared from field panel to field panel is that it can allow a technician to change or monitor certain aspects of many field panels from a single field panel. In many systems, one or more computer work stations, not shown in FIG. 1, are also provided that can access data from all of the field panels. The data sharing operations of field panels can take many protocols or forms, proprietary and open. Typically, however, the protocols used are specialized protocols for the industry, and devices communicated on the network 118 typically require specific configuration for that purpose. Even open protocols used in for field panel communications are specialized to the extent that the data formats and/or message formats are not readable by a standard, commercially available web browser.

From time to time a party may desire to access information from the building control system from a computer that is not specifically configured to communicate using the specific protocols of the building control system 118. For example, a user at a computer having a commercially available web browser, e.g. the web client 120, may desire to obtain information from the building control system. The embodiment of the present invention described herein enables such operation.

In particular, to obtain data in such a manner, the web client 120 communicates a request for a building control information to the field panel 112. The requested information may include information stored on, or at least derived from information stored on, any of the field panels 112, 114 and 116. The processing circuit 112a receives the request, and generates a responsive web page. To this end, the processing circuit 112a may have to obtain data stored locally, or may obtain data from one of the other field panels 114, 116 over the communication network 118. The processing circuit 112a then assembles the data into a web page, and provides the web page to the web client 120 via a communication circuit 112b.

In addition, for some building control information, for example, alarm information, the communication circuit 112b further provides a program to the web client 120 that is executable by a standard web browser. This program, when executed by the web client 120, automatically generates requests for updates to the certain types of information. Such requests are automatically transmitted from the web client 120 to the field panel 112. The field panel 112 receives the update request, obtains the updated information, and transmits the updated information to the web client 120 via the communication circuit 112b. As with the originally requested information, the field panel 112 may obtain the updated information either locally or from one of the other field panels 114, 116. In addition, will be appreciated that the updated information is typically transmitted as a new, updated web page. Alternatively, the updated information may be transmitted using another file protocol, such as an XML file, which is parsed by a program at the web client 120.

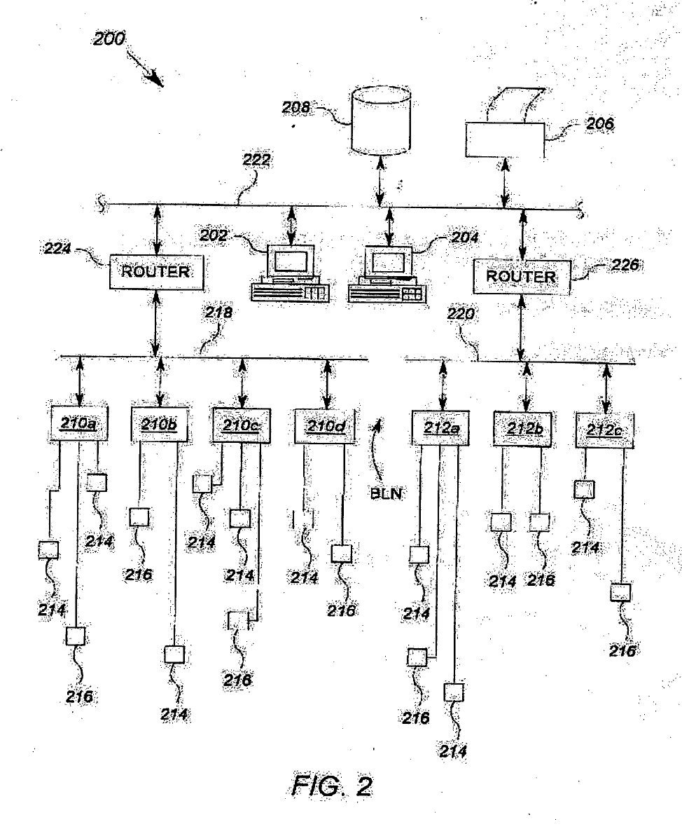

FIG. 2 shows another exemplary building control system 200 that incorporates aspects of the invention. The building control system 200 includes first and second control system computers 202, 204, a system printer 206, a system mass storage device 208, a first set of field panel devices 210, a second set of field panel devices 212, and plural control system devices 214 and 216. The embodiment in FIG. 2 features a building level network that includes several Ethernet local area networks, as will be discussed below. Elements that communicate on the building level network are considered to be nodes of the network. The control system computer 204, the system printer 206, the mass storage device 208 and the field panels 210a-210d and 212a-212c are all nodes of the logical building level network (BLN) of FIG. 2. As will be discussed further below, the control station 202 is physically connected to the nodes of the BLN, but is not itself a node of the logical BLN.

Referring now generally to the system 200, the control system devices 214 include sensors that obtain values representative of a process value within the building control system 200. For example, control system devices 214 may include temperature sensors, flow sensors, humidity sensors, air quality sensors. The control system devices 216 include actuators that affect outputs of the building control system 200. For example, the control system devices 216 may include ventilation damper actuators, hot water valve actuators, variable frequency drives, and other devices that can affect temperature, air flow or other aspects of a building.

The control system devices 214 and 216 are connected to various of the first and second sets of field panel devices 210 and 212, respectively. The first set of field panel devices includes field panel devices 210a, 210b, 210c and 210d, which are all connected to each other by an Ethernet local area network 218. The second set of field panel devices 212 includes field panel devices 212a, 212b and 212c, which are all connected to each other by an Ethernet local area network 220.

The Ethernet local area networks 218 and 220 are bus networks to which the field panel devices 210a-d and 212a-c, respectively are connected. Other nodes, not shown may also be connected to the Ethernet local area networks 218 and 220. The Ethernet local area networks 218 and 220 employ Ethernet standard transmission protocol, including standard Ethernet acknowledgement practices (in one-to-one or unicast messaging), standard Ethernet multicast and broadcast practices, and standard collision handling operations. Ethernet networks in general are well known.

The control stations 202, 204, the printing device 206 and the mass storage device 208 are all connected by an Ethernet network 222. The Ethernet network 222 is a bus network similar to the Ethernet local area networks 218 and 220. The Ethernet local area network 218 is connected to the Ethernet network 222 through a router 224 and the Ethernet local area network 220 is connected to the Ethernet network 222 through a router 226.

As discussed above, the field panels 210a-210d and 212a-212c, the control station 204, and optionally the mass storage device 208 are part of a logical level Internet Protocol (IP) network known as a building level network or BLN. The BLN uses the physical level Ethernet communication networks 218, 220 and 222. However, multiple logical IP level networks may share physical level networks such as the networks 218, 220 and 222. As is known in the building control system art, communication between field panels 210a-210d and 212a-212c and other nodes of the BLN is typically carried out using specialized building control system protocols, whether open standard or proprietary.

Each of the field panels 210a-210d and 212a-212c is preferably operable to receive sensor information from one or more building control devices 214, receive set point or other control information from an external device (such as another field panel 210a-210d, 212a-212c or a control station 202, 204). Each field panel 210a-210d and 212a-212c is preferably also operable to calculate a control output using the sensor information and/or the set point or other control information. The field panels 210a-210d and 212a-212c may suitably communicate the control outputs to building control devices 216 and/or other of the field panels. Each of the field panels 210a-210d and 212a-212c is also preferably operable to communicate sensor information, set point information, device status information, field panel status information, and the like to other field panels and other nodes of the BLN.

In accordance with this embodiment of the present invention, the field panel 210a further operates as a web server that generates web pages and provides the web pages to web clients. The web pages include, among other things, at least some building control system information. Such building control system information may include sensor values, control output values, and/or set point values from any of the field panels 210a-210d, 212a-212c, or information derived from any of such values.

The control stations 202, 204 are preferably computer workstations that include user interface equipment such as displays, keyboards, pointing devices, etc. The control stations 202, 204 can provide overall control and monitoring functions for the system 200, including providing user access to data generated by or for the field panels 210a-210d, 212a-212c. By way of example, the control stations 202, 204 may be able to obtain a sensor reading, for example a temperature sensor reading, from the field panel 210b in response to a request by a user. In another example, the control station 202 may be able to provide a set point flow value to one of the field panels, e.g. field panel 212c, which the field panel 212c would then use in determining a control output to provide to the appropriate actuator. Alarm information generated by any of the control devices 214, 216 or any of the field panels 210a-210d, 212a-212c may be received and displayed at the control stations 202, 204.

While both control stations 202 and 204 access building control information as described above, the control stations 202 and 204 access such information in different ways. In this embodiment, one of the control stations, the control station 202, includes a web client and is configured to receive web pages from the field panel 210a via the local area networks 118 and 122. To this end, the control station 202 may suitably include a commercially available web browser such as Internet Explorer available from Microsoft Corporation of Redmond, Wash., NetScape Navigator, or Safari available from Apple Computer. The control station 202 is thus operable to receive building control information of any of the field panels 210a-210d and 212a-212c through the web server field panel 210a.

As discussed further above, the other control station 204 is a node on the BLN, and is therefore configured to receive building control system data from the various field panels 210a-210d and 212a-212c directly, using the BLN protocols. The control station 204 is therefore specially configured to operate with the building control system 200, while the control station 202 may simply be a standard computer work station that includes a standard web browser. The control station 202 may suitably communicate with the field panel 210a using a TCP/IP protocol.

One example of a suitable control station that may be used as the control station 204 is an Insight™ brand workstation available for use in the Apogee™ building control system, both available from Siemens Building Technologies, Inc., of Buffalo Grove, Ill. The web client control station 202 may suitably be any of a number of general purpose, commercially available computers, including desktop computers, portable computers, web-enabled personal data assistants (via a wireless connection), etc.

The mass data store 208 is a device that stores system related data in one or more databases. The stored system-related data may include historical and statistical information regarding system operation, system configuration information, system graphics, as well as other information not necessarily used in the real-time (or substantially real-time) control operations of the field panels 210a-210d, 212a-212c.

In accordance with aspects of the invention, the use of IP communication networks for the field panels allows for ready communication between and among the field panels 210a-210d and the field panels 212a-212c, taking advantage of existing (or easily added) Ethernet network infrastructure. Moreover, the IP level BLN may use multiple Ethernet networks connected by routers, such as is shown by way of example in FIG. 2?. Communication between field panels and control stations is important in building control systems because control information, sensor information and even control outputs are often shared among the various field panels and control stations in the system. xxx

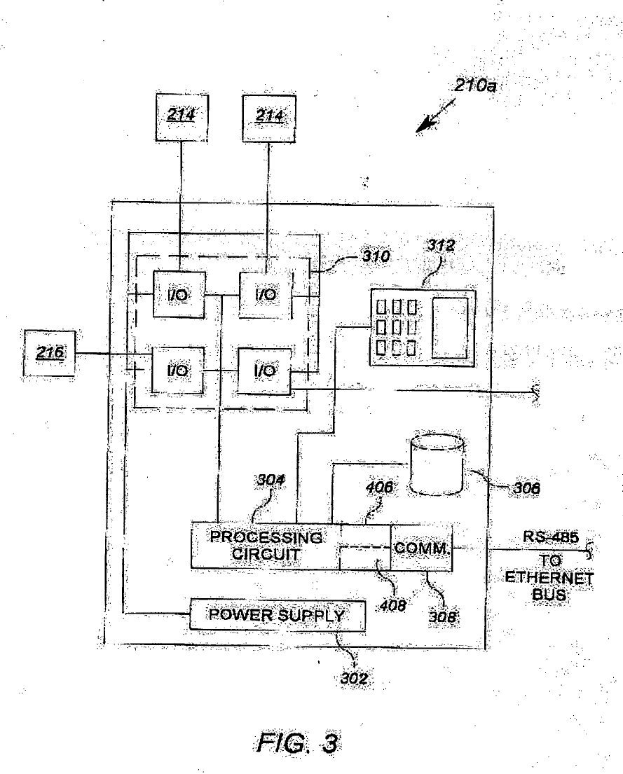

FIG. 3 shows an exemplary field panel 210a that incorporates aspects of the present invention. The field panel 210a includes a power supply 302, a processing circuit 304, a data store 306, an Ethernet communication circuit 308, and an I/O circuit 310. All of the elements of the field panel are supported (directly or indirectly) by a single housing, not shown. The field panel housing may suitably be similar to any commercially available field panel housing.

The power supply 302 is a circuit that is operable to convert AC utility power to AC and DC voltages used within the field panel 210a. Such devices are well known in the field panel art. The processing circuit 304 is a circuit that is capable of carrying out a set of instructions to implement the operations ascribed to the processing circuit 304 herein. To this end, the processing circuit 304 may suitably include a microprocessor, a microcontroller, discrete digital circuitry, a programmable logic device, and/or other processing elements, as well as related interface, clocking, and memory circuitry. Suitable circuits in various configurations would be known in the art. One suitable microprocessor is a PowerPC available from Motorola. In one preferred embodiment, a single microprocessor (and its non-processor support circuitry) carries out all of the operations attributed to the processing circuit 304 as described herein.

The data store 306 is a memory device or set of memory devices that have the capacity to retain building control information generated received by and/or maintained by the field panel 210a. The data store 306 may suitably include software instructions necessary to facilitate performance by the field panel 210a of control functions, communication functions, and web server functions. The field panel 210a may suitably include a hard disk or other non-volatile storage devices. Alternatively, or additionally, the field panel 210a may include random access memory or other volatile storage elements.

The Ethernet communication circuit 308 is a circuit that is operable to provide signals to and receive signals from a network bus connection using Ethernet communications protocols. The physical connection to the network bus may suitably be an RS-485 standard connection. In this example, the network bus is the network 218, as shown in FIG. 2. The Ethernet communication circuit 308 also includes the TCP/IP transport and network layer functionality that permits the exchange of information through the router 224, namely to the network 220, the control stations 202, 204, the printing device 206 and the mass storage device 208.

The Ethernet and TCP/IP communications protocols are well known in the art. Ethernet protocols generally require that each message from any device connected to the local area network 218 should propagate to each device on the local area network 218. While all nodes on the local area network 218 “see” each message transmitted on the local area network 218 or bus, only the nodes that are identified as the destination address “listen” to the message. Moreover, each Ethernet communication circuit 308 listens on the bus before transmitting messages, and is operable to send a jamming signal if a collision on the bus is detected. Messages addressed to nodes outside the local area network 218 are intercepted by the router 224, which then retransmits the message to the appropriate destination.

It will be appreciated that the block diagrams of functional blocks of FIG. 3 are largely depicted along functional lines, and that occasionally portions of the same circuit elements may perform portions of multiple functions. For example, the processing elements of the processing circuit 304 may provide at least some of the functionality required to effect TCP/IP communications over the local area network 218.

The I/O circuits 310 are ordinary I/O interface devices used to receive signals from various building control devices 214, and provide signals to one or more control devices 216. The I/O circuits 310 may have many configurations, and may include analog signal transceivers as well as digital communication circuit transceivers. The I/O circuits 310 include circuits that communicate with the building control devices 214 and 216 (see also FIG. 2). The configuration of the I/O circuits 310 depends upon the device (214, 216) to which the field panel 210a is connected.

The field panel 210a also includes a user interface 312, which may be relatively basic, such as a pushbutton keypad and a small LCD display panel. The user interface 312 allows a user to have local access to building control data in the data store 306, as well as data that can be obtained from other field panels. The user interface 312 may also allow a user to effect a change to building control data, for example, set points. Instead of a user interface 312, or in addition to it, the field panel 210a may include another communication circuit, not shown, that may be connected to a laptop computer or other portable computing device. The field panel may also include a local wireless connection, such as Bluetooth, through which a user may access data via a portable computing device. Such connections are known in the art.

The processing circuit 304 is preferably operable to carry out at least some control operations related to the connected building control devices 214 and 216. Such operations constitute the traditional operations of a building control system field panel device and are not discussed herein in detail. The processing circuit is further operable to generate web pages using building control data maintained locally or maintained at any of the other field panels 210b-210d and 212a-212c. To accomplish the foregoing, the processing circuit 304 includes a standard panel function 406 and a web server function 408.

In the exemplary embodiment described herein, the standard panel function 406 includes, among other things, the functions of maintaining and/processing point values, and of communicating information with other nodes on the BLN.

In particular, the standard panel function 406 of the processing circuit 304 is operable to maintain a number of point values in a manner normally associated with building control system. A point value is a value of control system variable, such as a sensor value, a control output value, or even a set point.

The maintenance of point values by processing circuit 304 includes receiving sensor values from attached sensors 214, generating control values for the actuator 216, receiving set point values from other nodes through the BLN, from the field panel user interface 312, or elsewhere. The maintenance of point values may further include generating alarms, performing scheduling routines, and performing advanced services such as trending of points. Preferably, many or most of the other field panels 210b-210d and 212a-212c maintain point values in a similar manner. The above described operations are known to those of ordinary skill in the art. Additional detail regarding alarm generation, scheduling and trending is provided below.

In particular, to facilitate the generation of alarms, the standard panel function 406 of the processing circuit 304 is operable to monitor point values, for example sensor point values, to determine whether those values exceed one or more alarm thresholds. If so, the processing circuit 304 generates an alarm event. The alarm event may be stored locally, or communicated to other nodes on the BLN such as the control station 204 of FIG. 2. As will be discussed below, various nodes of the building control system 200 of FIG. 2 may register or subscribe to alarm values of various points. Thus, when an alarm event for a point value occurs, the processing circuit 304 causes that alarm event to be communicated to all nodes on the BLN that have subscribed for alarms of that point.

In scheduling operations, the standard panel function 406 of the processing circuit 304 is further operable to use time of day information and/or date or season information in its control operations. For example, the processing circuit may perform a scheduling routine that automatically reduces the temperature set point in winter after 6:00 pm in order to conserve energy. Such a routine could further restore the normal set point at 7:30 am. Other scheduling routines may-change certain operations based on whether the current season is winter or summer. The details of such a scheduling routine will vary from application to application and would be known to those of ordinary skill in the art.

The processing circuit 304 in some embodiments is further operable to perform advanced functions, such as trending of certain point values. Trending of point values may include statistical calculations that are used to study the effectiveness of certain equipment or control algorithms. Again the details of such a trending will vary from system to system and would be known to those of ordinary skill in the art.

As discussed above, in addition to the maintenance of point values, the standard panel function 406 of the processing circuit 304 is further operable to cooperate with the communication circuit 308 to communicate point values and point value-related information to other nodes of the BLN. For example, as briefly mentioned above, the processing circuit 304 is operable to cause alarm event of point values to be communicated to other nodes on the BLN that subscribe to the alarms of that point value. The processing circuit 304 may similarly cooperate with communication circuit 308 to subscribe to and receive alarm event messages from other field panels. The processing circuit 304 may further receive externally generated command messages via the communication circuit 308. Command messages alter a set point value locally maintained within the field panel, or may even alter a locally maintained control output point value.

The standard panel function 406 of the processing circuit 304 and the communication circuit 308 are also configured to generate requests to other field panels to view point values maintained at those field panels, and to view trend values generated and maintained at other field panels. Similarly, the standard panel function 406 of the processing circuit 304 is operable to respond to such requests received from other nodes on the network. Thus, the processing circuit 304 may receive a request for trending data from another field panel. The processing circuit 304 would provide the trending data to the requesting field panel via the communication circuit 308 and the BLN.

The above described operations of the standard panel function 304 are generally known in the art. It will be appreciated that depending on the building control system, the standard panel function 304 may include more or less operations than those described above. However, the above described functions fairly represent a typical assortment of field panel control, monitoring and communication operations.

As discussed above, the processing circuit 304 also includes a web server function 408. The web server function 408 of the processing circuit is generally operable to receive hypertext transfer protocol “http” requests and generate web pages in HTML format responsive thereto. In general, the http requests may include requests for certain building control information, such as point values and other information, regarding one or more of the field panels of the BLN. In some embodiments, the web server function 408 may generate other types of web-browser compatible files, such as XML files, that are parsed and transformed by the web client using XSL, which is a stylesheet language for XML.

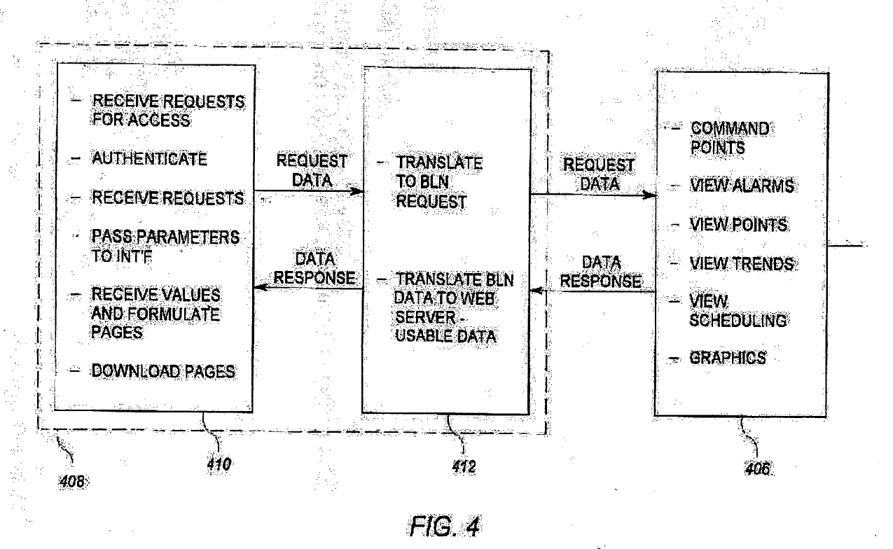

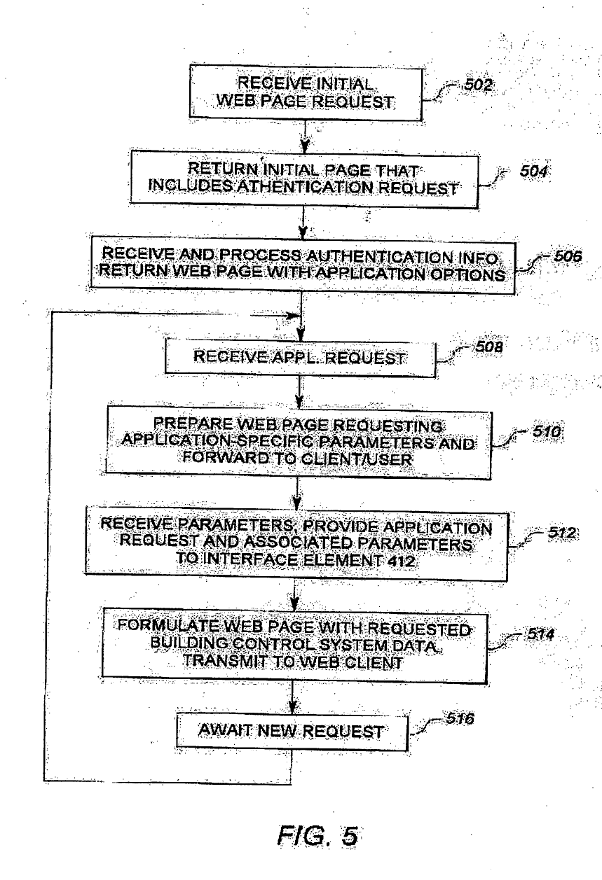

As will be described in further detail in connection with FIG. 4, the web server function 408 employs the standard field panel function 406 to obtain the building control data requested by the user. The web server function 408 then incorporates the obtained data into an HTML web page (or alternatively in an XML file) and provides the data to requesting entity. The web server function 408 is further operable to receive command values via an http request. The command values are values that are intended to change a set point or control value of the building control system. The web server function 408 causes the standard field panel function 406 to command the point value responsive to the http request.

FIG. 4 shows in further detail the standard field panel function 406 and the web server function 408. The web server function 408 includes a web server 410 and an interface element 412. The web server function 408 performs normal web server operations such as parsing of http requests, web page generation, and the transfer of files (html, .jpg, java applets (.jar), java scripts (.js), xml files (.xml), xml stylesheets (.xslt), etc. The interface element 412 performs applications that effectively translate data requests within the http requests into requests compatible with the standard panel function 406.

The web server 410 may suitably be commercially available web server software such as the Nucleus WebServ™ brand web server available from Accelerated Technology of Mobile, Alabama. The web server 410 may alternatively include a WINDOWS® CE web server that employs ASP pages or the like.

The general operation of the web server 410 to provide building control data to a web capable computer is described in connection with FIG. 5. In the discussion of FIG. 5, the entity requesting building control data from the web server 410 is referred to as the client/user. The client/user is a combination of a computer having a web browser such as the control station 202 of FIG. 2, and an authorized user.

Referring to FIG. 5, during normal operation, the web server 410 will receive from the client/user a request for a “welcome” page or initial page in step 502. The request may suitably be an http request for a URL, wherein the URL identifies the field panel 210a. For convenience, the URL may suitably be selected to have the same name as the field panel's identifier in the building control system. After step 502, the web server 410 proceeds to step 504.

In step 504, the web server 410 obtains from memory (i.e. the data store 306 of FIG. 3) an initial page that includes a form that requests authentication information. Authentication information typically includes a user name and password combination. In a normal operation, the client/user will submit a response using http requests that includes the authentication information. The web server 410 in step 506 receives the authentication information provided by the user and determines whether the user is authorized to view and/or control point values and other building control system information via the web server 410. Assuming the web server 410 determines that the user is authorized, the web server 410 provides a new web page to the client/user that includes a form in which specific building control information may be requested.

It will be appreciated that there may be multiple levels of authorization. In particular, some users may be authorized to view information only, while others may both view and command points. Other authorization levels may be used to selectively allow users access to particular subsets of the total population of field panels. In this case, it will be appreciated that the user's authentication status may referenced each time the user requests specific information from the web server 410 (see step 506).

In the embodiment described herein, the new web page provided in step 506 includes a graphic buttons (or pull down menu or the like) that allows the user to pick one of a plurality of applications or functions. An exemplary set of applications that may be called in the exemplary embodiment described herein include Command and View Points, Alarms, View Trends, View Scheduling, and Graphics. Command and View Points enables an authorized client/user view and change set point values or control point values on one or more of field panels in the BLN. Command and View Points also enables an authorized client/user view sensor, control and/or set point values at one or more of field panels in the BLN. Alarms enables an authorized client/user monitor and optionally acknowledge alarm events on one or more of field panels in the BLN. View Trends and View Scheduling enables an authorized client/user view trend data and scheduling information on one or more of field panels in the BLN. Graphics allows an authorized client/user to view and optionally control various points that are grouped together and displayed as a dynamic graphic. Further detail regarding the graphic operation is provided below in connection.

The web server 410 then proceeds to step 508. In step 508, the web server 410 receives a request from the client/user. The request may identify one of the plurality of applications available to the client/user. In response thereto, the web server 410 in step 510 prepares another web page that requests further parameters regarding the selected application. Such parameters include the identification of which points the user would like to view, command, track for alarms, trend, etc. For example, if the selected application is Command and View, then the web server 410 in step 510 formulates a web page that requests the identification of point values to be commanded or viewed. Similarly, if Alarms is selected, then the web server 410 in step 510 similarly formulates a web page that requests the building control system point or points for which Alarms are to be monitored. Other parameters may also be provided, such as format of presentation, etc.

The web page formulated in step 510 may present the request and method for responding in a variety of ways. In one embodiment, the web server 410 formulates a web page that includes a pull down menu with all of the available building control points for which the application may be executed. The client/user would then use the web browser interface to select one or more building control points from the pull down menu.

It is noted that while most applications (i.e. View and Command, Alarms, Trending, etc.) will require the client/user to select one or more building control points, all points are not typically available for all applications. For example, only some points may be commanded (i.e. controlled), only some points have alarm limits, and only some points have available trending data. In addition, the client/user may only have access to certain points based on their user authorization.

Thus, in one embodiment, the web server 410 in step 510 determines, based on the application selected and the client/user identity, those building control points that are available to be selected. The web server 410 then generates the web page to include a pull-down menu with those points. Other user-selected application parameter choices may be presented in the same manner. In other embodiments, the web page may merely include a form with space for receiving text input of the user. In any event, the web server 410 forwards the new page to the client/user to complete step 510.

Assuming the client/user formulates a response to the web page request generated in step 510, the web server 410 in step 512 receives the parameter information for the requested application.

In step 512, the web server 410 makes one or more calls to the interface element 412 that includes information identifying the both the application and the parameters related to the application. The interface element 412 receives the information, performs a corresponding task, and then returns point values or other requested building control system information to the web server 410.

For example, in the Command and View Points application, the web server 410 in step 512 provides to the interface element 412 the application call and the application parameters. The application parameters may include point value identifiers that specify the building control system point value(s) that the client/user wishes to view. The parameters may also include point value identifiers of points the client/user wishes to modify (i.e. command), and may further include the new value of the points that are modified. In such a case, the interface element 412 receives the parameters (and the request for the Command and View Points application) and generates a corresponding request using protocols and formats normally used to request information from the standard panel function 406. The standard panel function 406 then operates to retrieve (or change) the requested point values in the manner normally used by the field panels 210a-210d and 212a-212c. Thus, if the request includes a request for information from another field panel, the standard panel function 406 requests data from the other field panel using the normal BLN field panel protocols. The other field panel may suitably be oblivious as to whether the information is ultimately destined for the client/user in the form of a web page. Once the standard panel function 406 obtains the request value(s), it provides the retrieved information to the interface element 412. The interface element 412 thereafter parses the retrieved information from the BLN protocols and provides the parsed (possibly further processed) building control information to the web browser 410 for inclusion into the page to be sent to the client/user.

In another example, in the View Trends applications, the parameters provided by the web server 410 in step 512 may include point value identifiers that identifies the building control system point or points for which trending information is requested. The web server 410 forwards the parameters to the interface element 412. The interface element 412 then requests the trending data from the standard panel function 406. The standard panel function 406 obtains the requested data from its memory or from another field panel using normal BLN protocols, and returns the information to the interface device 412. The interface element 412 then builds a trending graph in a format that may be included in an HTML web page, and provide the trending graph data to the web server 410 for inclusion into the web page to be sent to the Client/User. In an alternative embodiment, the interface element 412 does not build the graph, but rather provides the data to the web server 410 which, in turn, sends it as an XML file. The web server 410 would also send a Java applet that builds the graph at the web client using the XML file.

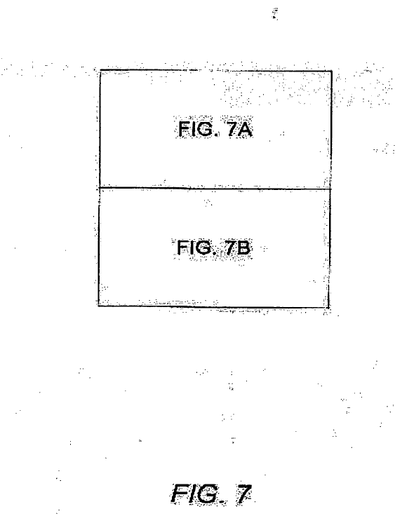

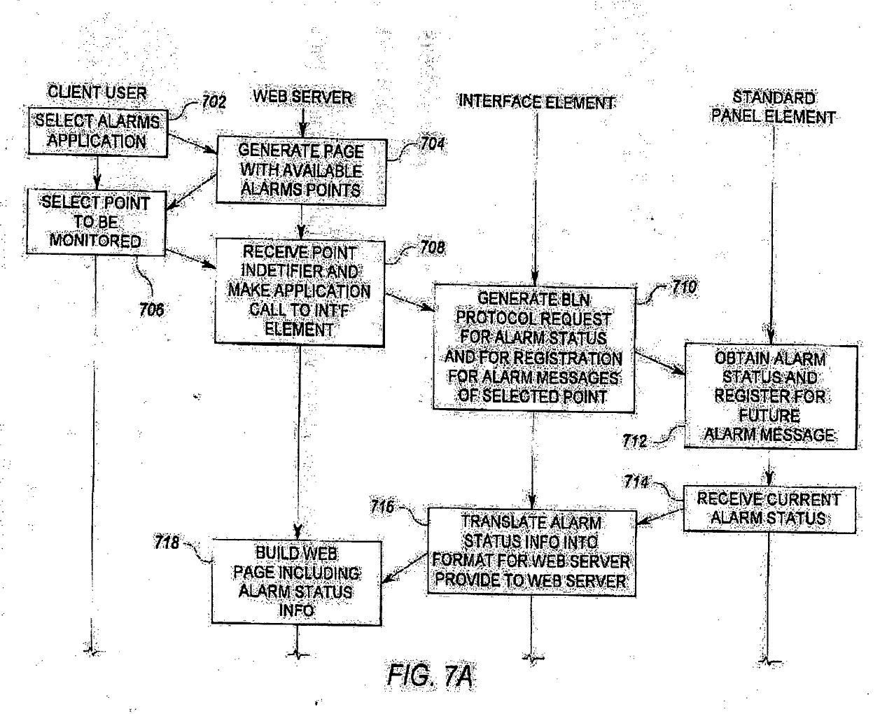

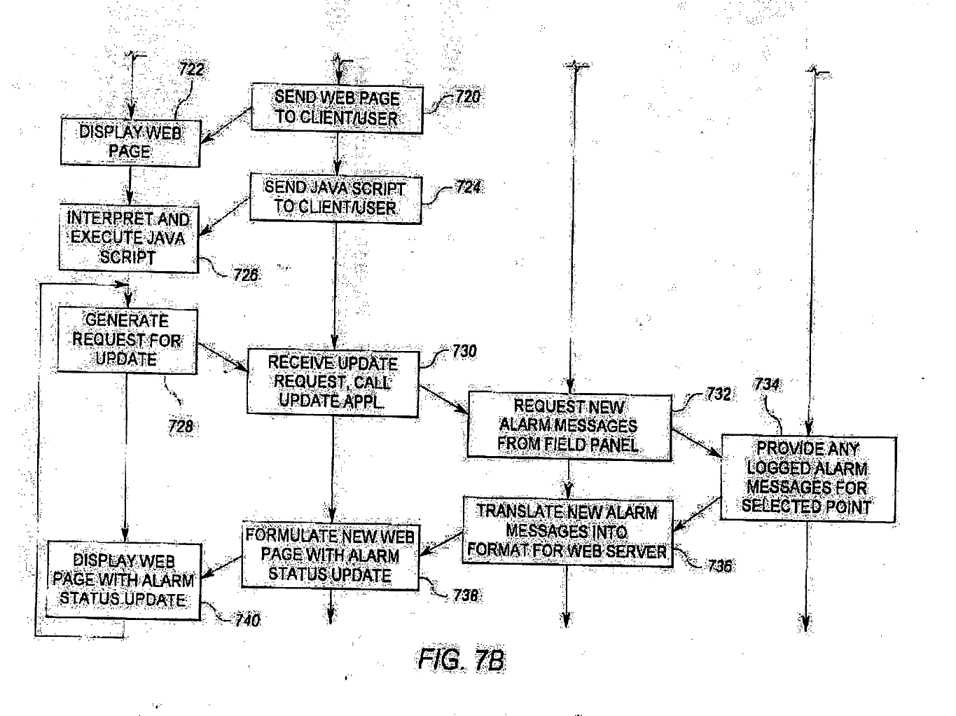

If the application requested is View Scheduling or Alarms, then interface element 412 and the standard panel function 406 operate in an analogous manner as that described above to obtain the necessary information. In the exemplary embodiment described herein, however, the Alarms application includes downloading a Java script to the client/user that causes the client/user web browser to automatically renew requests for Alarm messages. Further detail regarding the Alarm operation is provided below in connection with FIG. 7.

If the application is Graphics, then the web server 410 and interface element 412 operate to generate information that allows the client/user to display dynamic graphics that may include background elements as well as active graphic controls for various sensor values and set points or control points.

The parameters for such an application may be the identification of a “graphic” object that includes several related building control system values and a graphic environment with graphical controls. For example, a graphic of a room may include temperature sensor graphics, temperature set point control graphics, air flow meter graphics, etc. Such graphic object definitions may be stored at one or more nodes of the BLN. In such an operation, the web server 410 downloads various Java applets via Java jar files that cause the client/user to build graphics specifically at the client/user. Point value data is provided as XML files to allow for ease of update of values. To accomplish these graphic functions, the web server 410 and the interface element 412 may employ the techniques described in U.S. patent application Ser. No. 10/463,818, filed Jun. 17, 2003, U.S. Patent Publication No. US-2004-0049577-A1, which is incorporated herein by reference.

In any event, step 512 includes providing a request for performance of an application corresponding to the client/user request, and providing the parameters of the requested application. In step 514, the web browser 410 receives the requested building control data from the interface element 412. As discussed above the interface element 412 performs the requested application to obtain the building control data from the standard panel function 406.

In step 514, the web browser 410 formulates a web browser compatible transmission that includes the retrieved building control system data to the client/user. The web-browser compatible transmission may suitably be an HTML-compatible web page. In such a case, the web page may include stored web server text and/or graphics, building control values (converted to text) from the interface element 412, building control system graphics from the interface element 412, and Java scripts or applets. In other cases, the web-browser compatible transmission may include XML or other web-based data files that are parsed by special programs in the web browser. Such special programs may include previously downloaded Java applets scripts or XSL stylesheets.

An exemplary HTML page 602 generated by the web server 410 as it would appear on the client/user computer is shown in FIG. 6. The HTML page 602 is shown in a browser environment 604. The browser environment 604 includes tool bars 606 and the like, and a page display area 608. The HTML page 602 is located in the page display area of the environment 604. The HTML page 602 includes static data in the form of static background graphics 610, menu buttons 612 and template text 614, and further includes text derived from building control values 616. The background graphics 610, menu buttons 612 and template text 614 are all relatively static and thus are directly available to the web server 410, while the building control values are retrieved by the interface element 412 and standard panel function 406 of FIG. 4, as generally described herein.

Referring again to FIG. 5, after generation and transmission of the web browser compatible information, the web server 410 awaits a new request in step 516. Once a request for new data is received from the client/user, the web server returns to step 508 and proceeds accordingly.

Thus, in general, the web server 410 builds web pages (or other web browser web compatible files) that include dynamic building control data. The web server 410 builds such pages responsive to specific requests for pages the human user, for example, a user at the control station 202 of FIG. 2 or the web client 120 of FIG. 1. Requests for pages typically require deliberate action by the user in form of a new http request. One exception to this general rule is an alarm update function of the Alarms application.

The Alarms application operates in a manner in which the client/user may automatically receive updates to alarm messages for one or more points.

FIG. 7 shows an exemplary flow diagram of the operations of the client/user (which may suitably be an authorized user at the control station 202 of FIG. 2), the web server 410 (FIG. 4) of the field panel 210a, the interface element 412 (FIG. 4) of the field panel 210a, and the standard panel function 406 (FIG. 4) of the field panel 210a. In general, the operations of the web server 410 in FIG. 7 constitute a specific example of the performance of several of the steps of FIG. 5, described above. However, in FIG. 7, the operations of the other elements of the system are also included to illustrate how the various elements cooperate to generate and automatically update alarm information.

First, in step 702, the client/user selects the Alarms application and provides the selection information to the web server 410. The web server in step 704 receives the application and generates a new web page that allows the user to select from a set of points for which alarm monitoring is available, and for which the client/user is authorized. The web server 410 forwards the new web page to the client/user. It will be appreciated that step 704 is a specific case of step 508 of FIG. 5.

In step 706, the client/user receives the web page and in response, identifies a point for which alarm messages are to be monitored. An alarm message, as is known in the art, is a message that is generated by a field panel or other controller when one of the point values (e.g. sensor value or control output value) is out of range. The point identification information is transmitted to the web server 410 using normal techniques, for example, form elements of a web page, request parameters of URL, etc. In step 708, the web server 410 receives the transmission from the client/user, and provides the identified point information, as well as information identifying a request for alarm monitoring to the interface device 412.

In step 710, the interface device 412 receives the information and runs an application that generates a request, in the format used by the standard panel function 406, for a current alarm status for the identified point. The interface device 412 also requests to subscribe to alarm updates, for the identified point To this end, it will be appreciated that the standard field panel and other nodes on the BLN have the ability to subscribe or register for alarm messages from particular points on the BLN. It is in this manner, or a similar manner, that ordinary building control systems communicate non-life safety alarm conditions to control stations and other nodes on the network. In step 710, the interface device 412 causes the standard panel function 406 to request to receive all alarms from the identified point.

In step 712, the standard panel function 406 contacts the field panel on the BLN that maintains the identified point to be monitored (if that point is not monitored by the standard panel function 406 of the local panel). In particular, the standard panel function 406 contacts that field panel to request current alarm status and to request that all future alarms for the identified point be forwarded to the standard panel function 406.

In step 714, the standard panel function 406 receives the current alarm status and passes the information to the interface element 412. Then, in step 716, the interface element 412 provides the alarm status data to the web server 410 in a format required by the web server 410. In step 718, the web server 410 builds a web page that includes static environmental graphics and text, and which further includes the alarm status data. IN step 720, the web server 410 provides the web page to the client/user. In step 722, the client/user receives the web page data and displays the web page using standard web browser technology.

In step 724, the web server 410 further downloads a Java script that is to be executed on the client/user. The Java script is interpretable by the web browser at the client/user, as is well known in the art. The Java script is configured such that, when executed by the client/user, it causes the client user to automatically generate an http request for updates to the alarm status of the specified point.

In step 726, the client/user receives the downloaded Java script. The web browser of the client/user interprets and executes the Java script. In general, the Java script causes the client/user to automatically generate (i.e. without input from a user) an http request for updates to the alarm status information after a predetermined amount of time. Such an http request may simply be a request for a new web page, the new web page having updated alarm status. In step 728, it is assumed that the predetermined amount of time has passed and that the Java script causes the client/user to send the http request.

In step 730, the web server 410 receives the request for an alarm status update page and calls an alarm update application in the interface element 412. In step 732, the interface element 412 receives the alarm update status request and formulates a query to the standard panel function 406. The query requests an indication of whether any new alarm messages for the selected point have been received at the standard panel function 406. In particular, as discussed above in connection with step 710, the standard panel function 406 is registered to receive any new alarm messages pertaining to that particular point. When new alarm messages are received, the standard panel function 406 logs them, and therefore they are available when the interface element 412 queries for new alarm messages received.

In step 734, the standard panel function 406 returns log information representative of any new alarm messages received for the point. In step 736, the interface element 412 prepares the new alarm message information in a format that may be used by the web server 410 to generate a new web page. In step 738, the web server 410 generates a web page using the updated alarm message information generated by the interface element 412. If no new alarm message (or other change in alarm status) has been received, then the web server 410 may elect not to send an updated web page. Alternatively, the web server 410 may send a new web page with the same alarm status information. The web page, if generated, is provided to the client/user.

In step 740, the client/user displays the newly received web page with the updated alarm status, and then returns to step 728 to await the time period for automatically requesting new alarm status data.

Referring again generally to the web server operation, it will be appreciated that any of the web pages generated by the web server 410 may provide the client/user the ability to select a different application. This ability may be provided in the form of “buttons” on each web page that identify the available applications. (See the buttons menu 612 of FIG. 6). If the web server 410 receives such a request, then the web server 410 returns to step 508 of FIG. 5. However, if such a request is received during the Alarms application, then the web server 410 returns to step 508 of FIG. 5 and also executes an application at the interface element 412 to request no further alarm message status updates. In response to such a request, the interface element 412 performs a routine that essentially effectuates an order to cause the standard panel function 406 to cancel registration to the alarm status updates for the subject building control system point.

Thus, the above described invention allows for a web client interface to a building control system through a web browser that is embedded in a field panel. The field panel of typical advanced building control systems has the ability to obtain, control and monitor the data that is also available to the web client. However, the present invention allows for access both through proprietary (or open) BLN-specific protocols and through open standard web protocols.

It will be appreciated that the above described embodiments are merely exemplary, and that those of ordinary skill in the art may readily devise their own implementations and embodiments that incorporate the principles of the present invention and fall within the spirit and scope thereof. Other embodiments may employ other environments as well. For example, the field panels according to the invention may be configured to use wireless building level network communications, such as those employing the Konnex or Zigbee standards. The web connection between the field panel according to the invention and any web client may be through any known suitable medium for web communications.

1. A controller for use in a building control system, the controller comprising:
at least one input operably connected to receive sensor information;
at least one output operably connected to communicate control information;
a processing circuit configured to,
generate the control information based on the sensor information and at least one set point,
generate web pages including one or more building control values; and
at least one communication circuit operable to communicate the generated web pages to an external web client, the at least one communication circuit further operable to communicate an executable program to the external web client, the executable program operable to cause the external web client to automatically poll for updates to at least one of the one or more building control values.

2. The controller of claim 1, wherein the at least one input is operably connected to a sensor device.

3. The controller of claim 1, wherein the at least one output is operably connected to an actuator.

4. The controller of claim 1, wherein the one or more building control values comprises a plurality of values, and wherein the executable program is operable to cause the external web client to automatically poll for updates to less than all of the one or more building control values.

5. The controller of claim 4, wherein the executable program is operable to cause the external web client to automatically poll for an update to a first building control value, the first building control value indicating an alarm condition.

6. The controller of claim 1, wherein the processing circuit is further operable to cooperate with the at least one communication circuit to obtain the building control values from a remote device.

7. The controller of claim 6, wherein the controller constitutes a first node on a logical building network and the remote device comprises a second node on the logical building network.

8. The controller of claim 6, wherein the processing circuit is further operable to convert the obtained building control value into an HTML-web page compatible format.

9. A method for use in a building control system having a controller, the controller including at least one input operably connected to receive sensor information, at least one output operably connected to communicate control information, and a processing circuit, the method comprising:
a) generating, using the processing circuit, the control information based on the sensor information and at least one set point,
b) generating, using the processing circuit, web pages including one or more building control values,
c) communicating the generated web pages to an external web client; and
d) communicating an executable program to the external web client, the executable program operable to cause the external web client to automatically poll for updates to at least one of the one or more building control values.

10. The method of claim 9, further comprising:
receiving at least one of the one or more building control values from a second controller, and
incorporating the at least one of the one or more building control values into the generated web page.

11. The method of claim 9, further comprising receiving the sensor information from a sensor device.

12. The method of claim 9, further comprising providing the control information to an actuator.

13. The method of claim 9, wherein the one or more building control values comprises a plurality of values, and wherein the executable program is operable to cause the external web client to automatically poll for updates to less than all of the one or more building control values.

14. The method of claim 13, wherein the executable program is operable to cause the external web client to automatically poll for updates to a first building control value relating to a building control system alarm condition.

15. The method of claim 10, wherein the controller constitutes a first node on a logical building network and the second controller comprises a second node on the logical building network.

16. The method of claim 6, wherein the web page is an HTML-web page.

17. A controller for use in a building control system, the controller comprising:
at least one input operably connected to receive sensor information relating to a heating, ventilation and air conditioning (HVAC) system;
at least one output operably connected to communicate control information an element of the HVAC system;
a processing circuit configured to,
generate the control information based on the sensor information and at least one set point,
generate a web file including one or more building control values, the web file being readable by a standard web browser;
at least one communication circuit operable to communicate the generated web file to an external web client.

18. The controller of claim 17, wherein the processing circuit is further operable to cooperate with the at least one communication circuit to obtain the building control values from a remote device.

19. The controller of claim 18, wherein the controller constitutes a first node on a logical building network and the remote device comprises a second node on the logical building network.

20. The controller of claim 18, wherein the web file constitutes an HTML web page.
